(19) United States
(12) Patent Application Publication
(10) Pub. No.: US 2016/0275432 A1
(43) Pub. Date: Sep. 22, 2016

(54) TRENDING CHART REPRESENTATION OF HEALTHCARE LAW COMPLIANCE

(71) Applicant: ADP, LLC, Roseland, NJ (US)

(72) Inventors: Richard F. Guinness, Ringoes, NJ (US); Michelle D. Northey, Valparaiso, IN (US); Venkata V. Peddinti, Dayton, NJ (US)

(21) Appl. No.: 14/663,732

(22) Filed: Mar. 20, 2015

(51) Int. Cl. G06Q 10/06; G06F 17/30

(52) U.S. Cl. CPC G06Q 10/06393; G06F 17/30864

(57) ABSTRACT

Systems and methods for analyzing compliance with a healthcare law are provided. A method includes obtaining employee information about plural employees by querying at least one data source via computer-based network communication. The method also includes determining a respective trending parameter for each of the plural employees. The method further includes generating and displaying a trending chart in the user interface. The trending chart includes: a first curve based on the determined trending parameters of ones of the plural employees designated as part time, and a second curve based on the determined trending parameters of ones of the plural employees designated as full time. The obtaining, the determining, and the generating and displaying are performed by a trending tool running on a computing device.

### TECHNICAL FIELD

The invention relates to healthcare law compliance and, more particularly, to a method and system for obtaining, generating, and providing information to employers for determining healthcare law compliance.

### BACKGROUND

Under certain circumstances, the Affordable Care Act (ACA) requires employers to offer medical insurance to full-time employees or alternatively pay a penalty for not offering medical insurance to such employees. The penalty is also referred to as a “shared responsibility payment,” and the choice to provide coverage or pay the penalty has been termed “pay or play.”

A full-time employee may be defined as an employee who is employed for an average of 30 hours per week over a measurement period lasting between 3 to 12 consecutive months as chosen by the employer. Compliance with the ACA in this regard is based on actual work status over the previous measurement period. A problem arises in that employees' actual work status (e.g., number of actual hours worked) are often different from their designated status (e.g., part time or full time), and it is difficult for an employer to have an overall picture of healthcare compliance based on actual employee work hours. As a result, an employer may not find out that they are non-compliant with the ACA until after the measurement period, at which time it is too late for the employer to take action to address the non-compliance for the particular measurement period. This poses a significant problem to employers since the ACA penalties may be substantial.

### SUMMARY OF INVENTION

In accordance with a first aspect of the invention, there is a method of analyzing compliance with a healthcare law. The method includes obtaining employee information about plural employees by querying at least one data source via computer-based network communication. The method also includes determining a respective trending parameter for each of the plural employees. The method further includes generating and displaying a trending chart in the user interface. The trending chart includes: a first curve based on the determined trending parameters of ones of the plural employees designated as part time, and a second curve based on the determined trending parameters of ones of the plural employees designated as full time. The obtaining, the determining, and the generating and displaying are performed by a trending tool running on a computing device.

In accordance with another aspect of the invention, there is a computer system for analyzing compliance with a healthcare law. The computer system includes a hardware memory device that stores program instructions of a trending tool. The computer system also includes a hardware processor that executes the program instructions and causes the computer system to: receive a user input at a computer generated user interface; based on the user input, obtain employee information about plural employees by querying plural different databases via computer-based network communication; determine a respective trending parameter for each of the plural employees by applying a trending process to a portion of the obtained employee information; and generate and display a trending chart in the user interface. The trending chart includes: a first curve based on the determined trending parameters of ones of the plural employees designated as part time, and a second curve based on the determined trending parameters of ones of the plural employees designated as full time. The determined respective trending parameter for each of the plural employees comprises an average number of hours worked per week during a specified time period. The user input comprises the specified time period.

In accordance with another aspect of the invention, there is a computer program product for analyzing compliance with a healthcare law. The computer program product includes computer readable program instructions stored on computer readable storage medium. The computer readable program instructions are executable on a computing device to cause the computing device to: receive a user input at a computer generated user interface; based on the user input, obtain employee information about plural employees by querying a human resources database and a payroll database via computer-based network communication; determine a respective trending parameter for each of the plural employees by applying a trending process to a portion of the obtained employee information; and generate and display a trending chart in the user interface. The trending chart includes: a first curve based on the determined trending parameters of ones of the plural employees designated as part time, and a second curve based on the determined trending parameters of ones of the plural employees designated as full time. The determined respective trending parameter for each of the plural employees comprises an average number of hours worked per week during a specified time period. The user input comprises the specified time period. The table lists a determined trending status for each one of the plural employees.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIG. 1 is an illustrative architecture of a computing system implemented as embodiments of the present invention;

FIG. 2 shows an exemplary cloud computing environment in accordance with aspects of the invention;

FIG. 3 shows a block diagram in accordance with aspects of the invention;

FIG. 4 shows an exemplary user interface that illustrate functionality in accordance with aspects of the invention; and

FIG. 5 shows a flow diagram of an exemplary process in accordance with aspects of the invention.

### DETAILED DESCRIPTION OF ASPECTS OF THE INVENTION

The invention relates to healthcare law compliance and, more particularly, to a method and system for obtaining, generating, and providing information to employers for determining healthcare law compliance. According to aspects of the invention, the processes and systems provide many technical solutions to recently discovered problems associated with compliance issues. Specifically, aspects of the invention include generating a trending chart for a group of employees based on a combination of the designated work status of each employee and a determined trending status of the employee. In embodiments, the trending status for each employee is determined based on actual hours worked by the employee over a specified time period. The trending chart visually displays the designated status and the trending status of all employees of a group of plural employees, which is useful in making decisions regarding actions that affect healthcare law compliance.

The technical solutions provided herein allow trending charts of different variations to be generated on a computing system and displayed on a display including a web page. For example, in embodiments, the user (e.g., an employer) can designate a time period for which to generate the trending chart. The user may also select different groups of employees to use as the basis for generating the trending chart. In addition to the trending chart, the system and process are also configured to display a listing of all the employees that are represented by the trending chart in which listing each employee is shown with their individual trending status and other data. In embodiments, the system and process are configured to determine and provide an industry or targeted baseline for comparison. The system and process may also be configured to determine and provide estimations of financial costs for what-if scenarios for different actions based on the determined trending status of the employees. In this manner, implementations of the invention provide the technological solution of viewing designated status and trending status of a group of employees and of each employee within the group. Implementations of the invention also provide easy identification for actions when comparing with a targeted baseline.

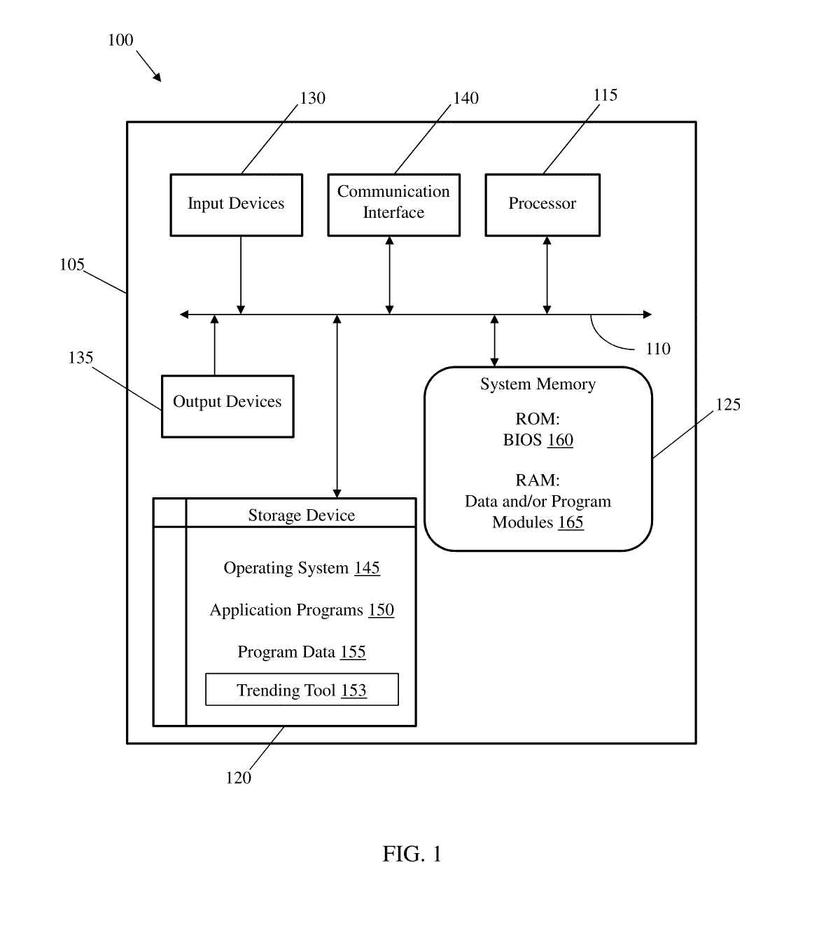

FIG. 1 is an illustrative architecture of a computing system 100 implemented as embodiments of the present invention. The computing system 100 is only one example of a suitable computing system and is not intended to suggest any limitation as to the scope of use or functionality of the invention. Also, computing system 100 should not be interpreted as having any dependency or requirement relating to any one or combination of components illustrated in computing system 100.

As shown in FIG. 1, computing system 100 includes a computing device 105. The computing device 105 can be resident on a network infrastructure such as within a cloud environment, or may be a separate independent computing device (e.g., a computing device of a third party service provider). The computing device 105 may include a bus 110, a processor 115, a storage device 120, a system memory 125, one or more input devices 130, one or more output devices 135, and a communication interface 140.

The bus 110 permits communication among the components of computing device 105. For example, bus 110 may be any of several types of bus structures including a memory bus or memory controller, a peripheral bus, and a local bus using any of a variety of bus architectures to provide one or more wired or wireless communication links or paths for transferring data and/or power to, from, or between various other components of computing device 105.

The processor 115 may be one or more conventional processors or microprocessors that include any processing circuitry operative to interpret and execute computer readable program instructions, such as program instructions for controlling the operation and performance of one or more of the various other components of computing device 105. In embodiments, processor 115 interprets and executes the processes, steps, functions, and/or operations of the present invention, which may be operatively implemented by the computer readable program instructions. In embodiments, processor 115 may receive input signals from one or more input devices 130 and/or drive output signals through one or more output devices 135. The input devices 130 may be, for example, a keyboard or touch sensitive user interface (UI) as further described below. The output devices 135 can be, for example, any display device, printer, etc., as further described below.

The storage device 120 may include removable/non-removable, volatile/non-volatile computer readable media, such as, but not limited to, non-transitory media such as magnetic and/or optical recording media and their corresponding drives. The drives and their associated computer readable media provide for storage of computer readable program instructions, data structures, program modules and other data for operation of computing device 105 in accordance with the different aspects of the present invention In embodiments, storage device 120 may store operating system 145, application programs 150, and program data 155 in accordance with aspects of the present invention.

The system memory 125 may include one or more storage mediums, including for example, non-transitory media such as flash memory, permanent memory such as read-only memory (“ROM”), semi-permanent memory such as random access memory (“RAM”), any other suitable type of storage component, or any combination thereof. In some embodiments, an input/output system 160 (BIOS) including the basic routines that help to transfer information between the various other components of computing device 105, such as during start-up, may be stored in the ROM. Additionally, data and/or program modules 165, such as at least a portion of operating system 145, application programs 150, and/or program data 155, that are accessible to and/or presently being operated on by processor 115 may be contained in the RAM.

In embodiments, the application programs 150 comprises a trending tool 153 that includes special-purpose program code that is specifically configured to perform one or more of the functions described herein, e.g., determine employee trending status, generate a trending chart, etc. For example, program code of the trending tool 153 may be loaded as one or more program modules 165 and executed by the processor 115 to cause the computing device 105 to perform one or more of the functions described herein.

The one or more input devices 130 may include one or more mechanisms that permit an operator to input information to computing device 105, such as, but not limited to, a touch pad, dial, click wheel, scroll wheel, touch screen, one or more buttons (e.g., a keyboard), mouse, game controller, track ball, microphone, camera, proximity sensor, light detector, motion sensors, biometric sensor, and combinations thereof. The one or more output devices 135 may include one or more mechanisms that output information to an operator, such as, but not limited to, audio speakers, headphones, audio line-outs, visual displays, antennas, infrared ports, tactile feedback, printers, or combinations thereof.

The communication interface 140 may include any transceiver-like mechanism (e.g., a network interface, a network adapter, a modem, or combinations thereof) that enables computing device 105 to communicate with remote devices or systems, such as a mobile device or other computing devices such as, for example, a server in a networked environment, e.g., cloud environment. For example, computing device 105 may be connected to remote devices or systems via one or more local area networks (LAN) and/or one or more wide area networks (WAN) using communication interface 140.

As discussed herein, computing system 100 may be configured to generate and present a user interface including a trending chart and related functionality as described herein. In particular, computing device 105 may perform tasks (e.g., process, steps, methods and/or functionality) in response to processor 115 executing program instructions contained in a computer readable medium, such as system memory 125. The program instructions may be read into system memory 125 from another computer readable medium, such as data storage device 120, or from another device via the communication interface 140 or server within or outside of a cloud environment. In some embodiments, an operator may interact with computing device 105 via the one or more input devices 130 and/or the one or more output devices 135 to facilitate performance of the tasks and/or realize the end results of such tasks in accordance with aspects of the present invention. In additional or alternative embodiments, hardwired circuitry may be used in place of or in combination with the program instructions to implement the tasks, e.g., steps, methods and/or functionality, consistent with the different aspects of the present invention. Thus, the steps, methods and/or functionality disclosed herein can be implemented in any combination of hardware circuitry and software.

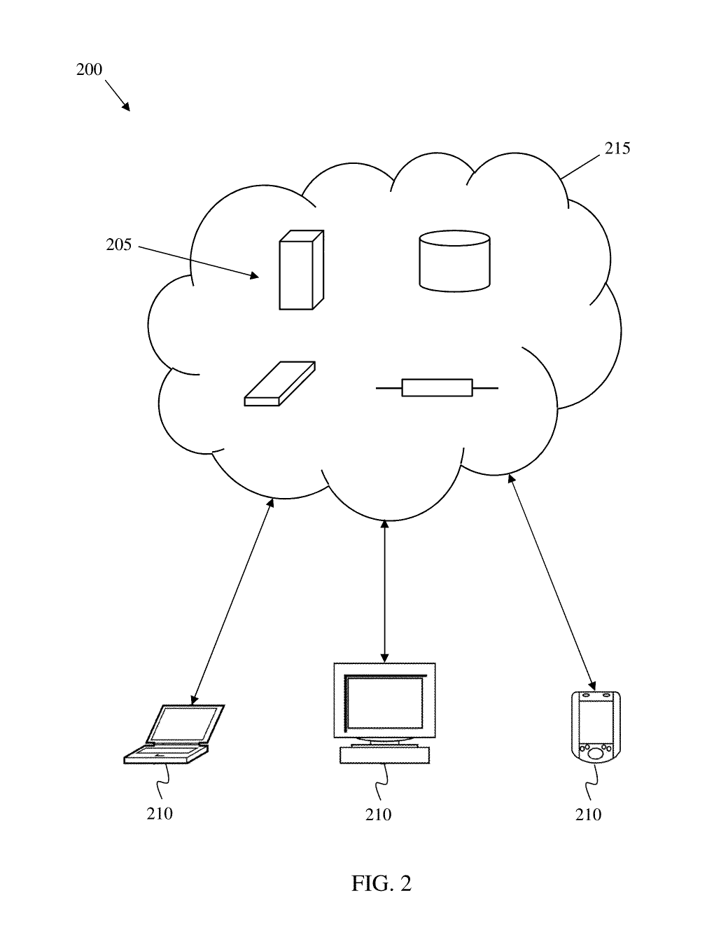

FIG. 2 shows an exemplary cloud computing environment 200. Cloud computing is a computing model that enables convenient, on-demand network access to a shared pool of configurable computing resources, e.g., networks, servers, processing, storage, applications, and services, that can be provisioned and released rapidly, dynamically, and with minimal management efforts and/or interaction with the service provider. In embodiments, one or more aspects, functions and/or processes described herein may be performed and/or provided via cloud computing environment 200.

As depicted in FIG. 2, cloud computing environment 200 includes cloud resources 205 that are made available to client devices 210 via a network 215, such as the Internet. Cloud resources 205 can include a variety of hardware and/or software computing resources, such as servers, databases, storage, networks, applications, and platforms. Cloud resources 205 may be on a single network or a distributed network. Cloud resources 205 may be distributed across multiple cloud computing systems and/or individual network enabled computing devices. Client devices 210 may comprise any suitable type of network-enabled computing device, such as servers, desktop computers, laptop computers, handheld computers (e.g., smartphones, tablet computers), set top boxes, and network-enabled hard drives. Cloud resources 205 are typically provided and maintained by a service provider so that a client does not need to maintain resources on a local client device 210. In embodiments, cloud resources 205 may includes one or more computing system 100 of FIG. 1 that is specifically adapted to perform one or more of the functions and/or processes described herein.

Cloud computing environment 200 may be configured such that cloud resources 205 provide computing resources to client devices 210 through a variety of service models, such as Software as a Service (SaaS), Platforms as a service (PaaS), Infrastructure as a Service (IaaS), and/or any other cloud service models. Cloud resources 205 may be configured, in some cases, to provide multiple service models to a client device 210. For example, cloud resources 205 can provide both SaaS and IaaS to a client device 210. Cloud resources 205 may be configured, in some cases, to provide different service models to different client devices 210. For example, cloud resources 205 can provide SaaS to a first client device 210 and PaaS to a second client device 210.

Cloud computing environment 200 may be configured such that cloud resources 205 provide computing resources to client devices 210 through a variety of deployment models, such as public, private, community, hybrid, and/or any other cloud deployment model. Cloud resources 205 may be configured, in some cases, to support multiple deployment models. For example, cloud resources 205 can provide one set of computing resources through a public deployment model and another set of computing resources through a private deployment model.

One or more cloud resources 205 may be conceptually structured in multiple layers. In one example, the layers include a firmware and hardware layer, a kernel layer, an infrastructure service layer, a platform service layer, and an application service layer. The firmware and hardware layer may be the lowest layer upon which the other layers are built, and may include generic contributing nodes (e.g., data centers, computers, and storage devices) geographically distributed across the Internet and provide the physical resources for implementing the upper layers of the cloud service provider. The kernel layer is above the firmware and hardware layer and may include an operating system and/or virtual machine manager that host the cloud infrastructure services. The kernel layer controls and communicates with the underlying firmware and hardware layer through one or more hardware/firmware-level application programming interfaces (APIs). The infrastructure service layer is above the kernel layer and may include virtualized resources, such as virtual machines, virtual storage (e.g., virtual disks), virtual network appliances (e.g., firewalls), and so on. The infrastructure service layer may also include virtualized services, such as database services, networking services, file system services, web hosting services, load balancing services, message queue services, map services, e-mail services, and so on. The platform service layer is above the infrastructure service layer and may include platforms and application frameworks that provide platform services, such as an environment for running virtual machines or a framework for developing and launching a particular type of software application. The application service layer is above the platform service layer and may include a software application installed on one or more virtual machines or deployed in an application framework in the platform service layer. The software application can also communicate with one or more infrastructure service components (e.g., firewalls, databases, web servers, etc.) in the infrastructure service layer.

In another example, one or more cloud resources 205 may be conceptually structured in functional abstraction layers including a hardware and software layer, a virtualization layer, a management layer, and a workloads layer. The hardware and software layer may include hardware and software components such as mainframes, RISC (reduced instruction set computer) architecture based servers, storage devices, networks and networking components, application server software, and database software. The virtualization layer may include virtual entities such as virtual servers, virtual storage, virtual networks, virtual applications, and virtual clients. The management layer may provide functions such as resource provisioning, metering and pricing, security, user portals, service level management, and service level agreement planning and fulfillment. The workloads layer may provide functions for which the cloud computing environment is utilized, such as mapping and navigation, software development and lifecycle management, data analytics and processing, and transaction processing.

In embodiments, software and/or hardware that performs one or more of the aspects, functions and/or processes described herein may be accessed and/or utilized by a client (e.g., an enterprise or an end user) as one or more of an SaaS, PaaS and IaaS model in one or more of a private, community, public, and hybrid cloud. Moreover, although this disclosure includes a description of cloud computing, the systems and methods described herein are not limited to cloud computing and instead can be implemented on any suitable computing environment.

Cloud resources 205 may be configured to provide a variety of functionality that involves user interaction. Accordingly, a user interface (UI) can be provided for communicating with cloud resources 205 and/or performing tasks associated with cloud resources 205. The UI can be accessed via a client device 210 in communication with cloud resources 205. The UI can be configured to operate in a variety of client modes, including a fat client mode, a thin client mode, or a hybrid client mode, depending on the storage and processing capabilities of cloud resources 205 and/or client device 210. Therefore, a UI can be implemented as a standalone application operating at the client device in some embodiments. In other embodiments, a web browser-based portal can be used to provide the UI. Any other configuration to access cloud resources 205 can also be used in various implementations.

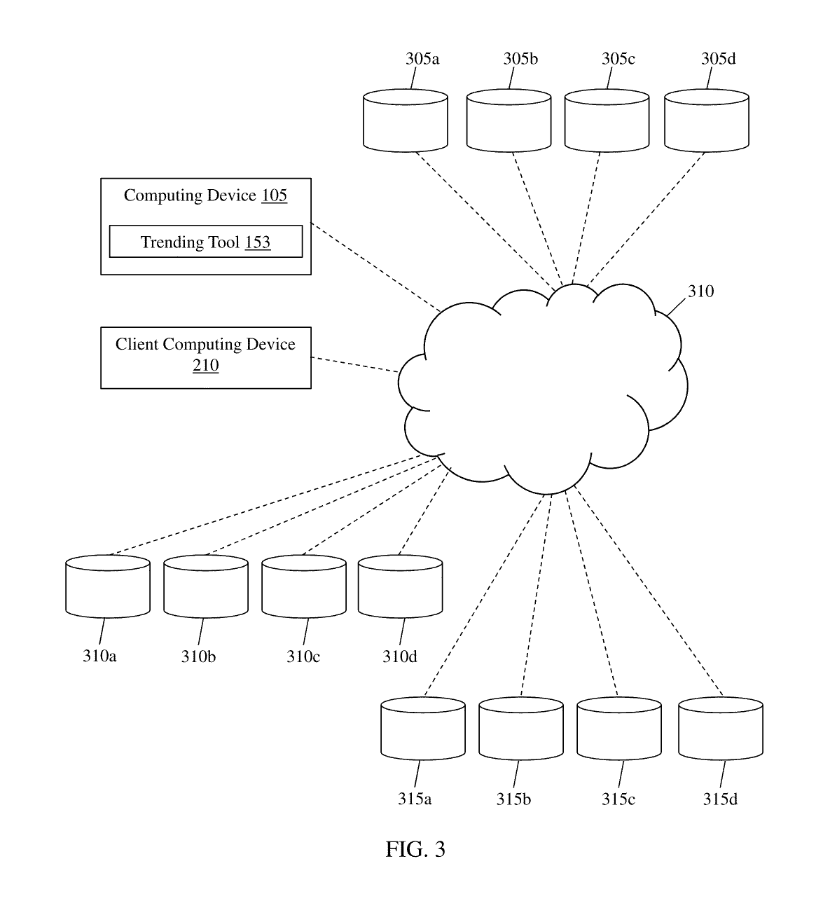

FIG. 3 shows a block diagram of a networked environment in accordance with aspects of the invention. In embodiments, a computing device 105 running the trending tool 153 communicates with a plurality of databases 305a, 305b, 305c via a network 310. The network 310 may be any suitable communications network or combination of networks, including but not limited to a local area network (LAN), a general wide area network (WAN), and/or a public network (e.g., the Internet). In cloud implementations, the network 310 may constitute the network 215 described with respect to FIG. 2.

In embodiments, the databases comprise a human resources (HR) database 305a, a benefits database 305b, a payroll database 305c, and a leaves database 305d that are normally separate and not maintained as a single data source. In fact, these different databases 305a, 305b, 305c, 305d include disparate information and disparate fields such that information in each of these databases would not be combinable due to technological issues, such as integration issues known to those of skill in the art. The HR database 305a may include information for each employee such as: employee name, employee state of residence, employee designated status (full time or part time), entity (employer) name, and group name to which the employee belongs within the entity. The benefits database 305b may include information for each employee such as: whether medical insurance (if any) is offered to each employee, the cost to the employer of the medical insurance that is offered, and whether the employee has accepted the offered medical insurance. The payroll database 305c may include information for each employee such as: actual hours worked by the employee including dates the hours were worked, hourly pay rate of the employee. The leaves database 305d may include any leave taken by the employee, including special unpaid leave (e.g., Family and Medical Leave Act (FMLA), Uniformed Services Employment and Reemployment Rights Act (USERRA), or for jury duty) including dates the leave was taken and how many hours of leave was taken. As these databases include such different information, prior to implementations of the systems and processes of the invention, there was no need for any single entity to combine or integrate such information together as there was no identifiable reason to even consider using such information together—and to the extent that there may have been such a purpose, such information was not capable of being combined in any logical or meaningful manner. One or more of the databases 305a-d may be maintained by the employer or by a service provider that provides services (e.g., payroll services) to the employer. In embodiments, the data contained in the databases 305a-d may be searched based on a query by the trending tool 153, and data that satisfies the query may be transmitted to the trending tool 153 via the network 310. The tending tool 153 may use the data received from one or more of the databases 305a-d in generating the trending chart and other data as described herein.

In embodiments, the computing device 105 may be maintained by a third party service provider which would then have access to plural databases of plural different employers. For example, databases 305a-d may include an HR database, benefits database, a payroll database, and a leaves database of a first employer, databases 310a-d may include an HR database, benefits database, a payroll database, and a leaves database of a second employer, and databases 315a-d may include an HR database, benefits database, a payroll database, and a leaves database of an n^{th} employer, where n equals any desired integer. In this way, the computing device 105 associated with the third party service provider can access these types of databases for providing services (e.g., payroll, benefits management, etc.) to plural different employers.

In an exemplary embodiment, the computing device 105 including the trending tool 153 is utilized directly by a user, e.g., an employer. In another exemplary embodiment, the computing device 105 and/or the trending tool 153 is a cloud resource 205 that is accessed by a client computing device 210, e.g., as described with respect to FIG. 2. For example, the client computing device 210 may run a client application that is executed by and/or under the control of the user. The client application may interface with the computing device 105 via the network, and the computing device 105 may perform the functions described herein and transmit data to the client computing device 210 for displaying data on the client computing device 210 via the client application.

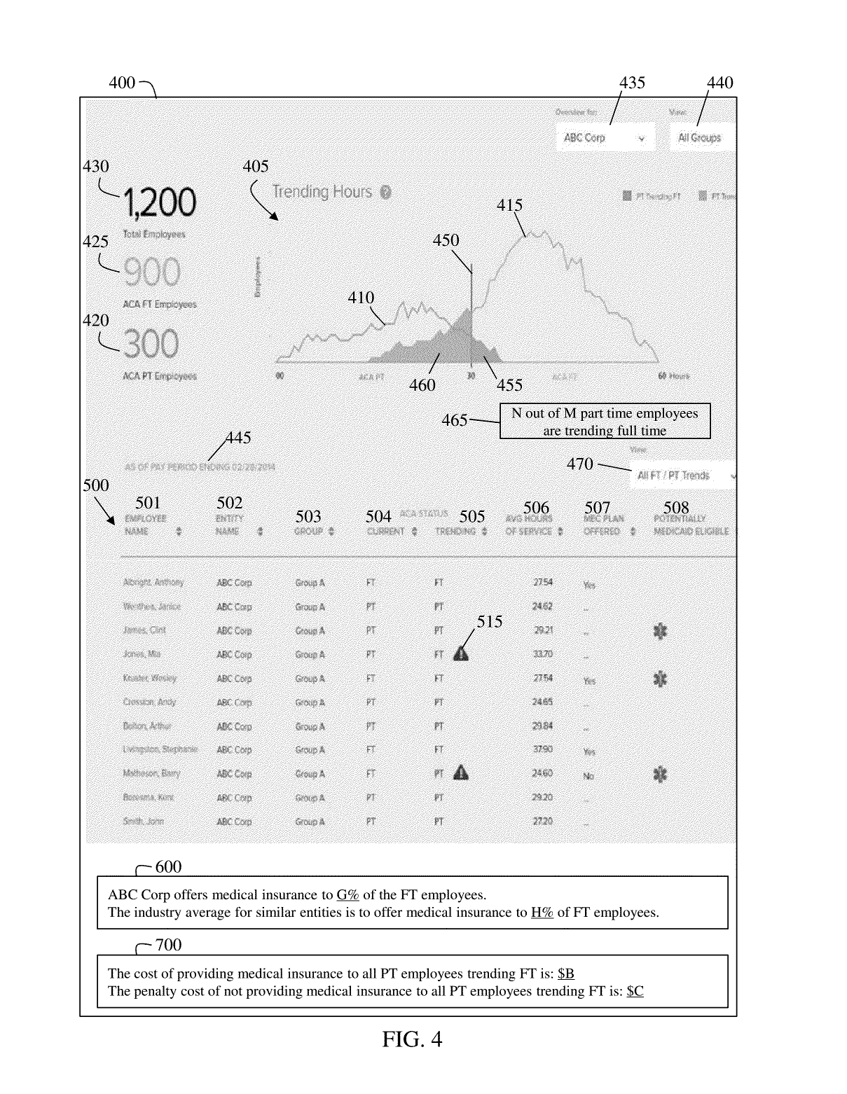

FIG. 4 shows an exemplary user interface (UI) 400 that includes a trending chart 405 that is generated by the computing device 105 running the trending tool 153 in accordance with aspects of the invention. In embodiments, the trending chart 405 includes a first curve 410 (e.g., plotted line) that is based on determined trending parameters of employees that are designated as part time, and a second curve 415 (e.g., plotted line) that is based on determined trending parameters of employees designated as full time. In the example shown, the determined trending parameter is average hours worked per week, the horizontal axis of the trending chart 405 corresponds to a numerical value of the trending parameter (i.e., average hours worked per week), and the vertical axis corresponds to number of employees. The UI 400 also includes an indication 420 of the number of part time employees, an indication 425 of the number of full time employees, and an indication 430 of the total number of employees that are represented in the trending chart 405.

In embodiments, the UI 400 also includes an input field 435 in which a user may select an entity (e.g., an employer) from a plurality of entities for which to construct the trending chart 405. The UI 400 may also include an input field 440 in which the user may select a group from a plurality of groups defined for the selected entity. For example, a single employer may have employees in plural different states, and the employees in each state may be categorized into groups that are selectable via input field 440. Other groups of employees are also contemplated for use with the invention.

The UI 400 may also include an input field 445 in which the user may provide input that defines a date range (e.g., a specified time period) for which to construct the trending chart 405. For example, the system may be configured to permit the user to utilize the input field 445 to designate a start date and an end date of the specified time period. As another example, the system may be configured to permit the user to utilize the input field 445 to designate an end date, where the system automatically determines the start date based on a combination of the designated end date and a predefined measurement period (e.g., 3 months, 6 months, 12 months, etc.). For example, the specified time period may be determined based on two items of information: a date specified by the user at field 445, and a predefined measurement period defined by the entity (employer). For example, the ACA permits an employer to select a measurement period in a range of 3 to 12 months when analyzing hours of service worked by an employee for the purpose of determining whether the employee is deemed a full time employee. In embodiments, the system determines the employer-specified measurement period (e.g., 6 months), for example, by accessing this data from memory storage of the computing device. The system sets the user input date (e.g., the pay period ending Feb. 28, 2014) as one bound of the specified time period for generating the trending chart. The system determines the other bound of the specified time period by subtracting the employer-specified measurement period from the user-specified date (e.g., Feb. 28, 2014 minus 6 months equals Aug. 28, 2013).

Still referring to FIG. 4 and in accordance with aspects of the invention, the computing device running the trending tool generates the UI 400 including the trending chart 405 by receiving input from a user, obtaining data from plural disparate data sources based on the input from the user, and applying at least one trending process to the obtained data. In embodiments, the plural disparate data sources are the HR database 305a, benefits database 305b, payroll database 305c, and the leaves database 305d as described with respect to FIG. 3, although other data sources may be used.

In the illustrative example shown in FIG. 4, the user has selected “ABC Corp” as the entity at field 435 and “All Groups” as the group at field 440. The user has also specified the time period “As of the pay period ending 02/28/2014” at field 445. Based on these inputs, the system (e.g., the system comprising the computing device running the trending tool) queries the HR database to obtain data indicating the name, residence (e.g., city and state) and designated status (e.g., part time or full time) for each employee of all groups of ABC Corp over the user specified time period. The system also queries the payroll database and/or leaves database to obtain data indicating, for each identified employee, how many hours they actually worked over the specified time period, and how much and what types of leave were taken during the specified time period. The system also queries the benefits database to obtain data indicating, for each identified employee, whether the entity (ABC Corp) has offered medical insurance to the employee during the specified time period.

With continued reference to the example depicted in FIG. 4, after querying the databases and obtaining the data, the system generates the trending chart 405 by applying at least one trending process to a portion the obtained data to determine a trending parameter for each identified employee. In embodiments, the trending process is an averaging routine and the trending parameter is an average number of hours worked by the employee per week during the specified time period. Specifically, the trending process may be a specially programmed module that is part of the trending tool and that is configured to determine an average number of hours worked by each employee based on the actual hours worked data obtained from the payroll database and by calculating an average number of hours per week for each employee for the specified time period. The trending process may be configured to factor in hours claimed by an employee for certain types of leave. For example, the trending process may be configured to determine the average hours of service per week for an employee during the specified time period, excluding certain leave (e.g., a special unpaid leave period), and using that average for the employee for the entire specified time period. As another example, the trending process may be configured to determine the average hours of service per week for an employee during the specified time period by crediting the employee with hours of service for special unpaid leave at a rate equal to the average weekly rate at which the employee was credited during the other weeks in the specified time period.

After determining the trending parameter for each employee of the selected group and the selected entity and for the specified time period, the system generates the trending chart 405 by plotting the determined trending parameters for all part time employees using curve 410 and by plotting the determined trending parameters for all full time employees using curve 415. The data defining whether an employee is designated as part time or full time may be obtained from the HR database, which may be separate from the payroll database that is queried to obtain actual hours worked for determining the average hours worked per week for each employee for the specified time period. In this manner, the system may be configured to query at least two different databases in the process of generating the trending chart 405.

Still referring to FIG. 4, in embodiments the trending chart 405 includes a threshold indicator 450, which may correspond to a threshold value that is defined by a healthcare law for determining whether an employee is part time or full time for purposes of determining compliance with the law. In a particular example, the threshold value is 30 hours per week as defined by the ACA, although other threshold values may be used within the scope of the invention. In embodiments, the employees trending status is determined by comparing their tending parameter to the threshold value. For example, using a threshold value of 30, an employee whose determined trending parameter equals less than 30 hours per week has a trending status as part time, while an employee whose determined trending parameter equals more than 30 hours per week has a trending status as full time.

According to aspects of the invention, the system provides a first visual indication in the trending chart 405 of how many part time employees are trending on the full time side of the threshold indicator 450, and a second visual indication of how many full time employees are trending on the part time side of the threshold indicator 450. In embodiments, the first visual indication is a first solid color in an area 455 that is both under the curve 410 and on the full time side of the threshold indicator 450, the second visual indication is a second solid color in the area 460 that is both under the curve 415 and on the part time side of the threshold indicator 450. Since curve 410 is based on (corresponds to) employees that are designated as part time, the chart 405 provides a fast visual indication of which of these part time employees are trending part time (i.e., to the left of threshold line 450) and which of these part time employees are trending full time (i.e., to the right of threshold line 450). Further, since curve 415 is based on (corresponds to) employees that are designated as full time, the chart 405 provides a fast visual indication of which of these full time employees are trending part time (i.e., to the left of threshold line 450) and which of these full time employees are trending full time (i.e., to the right of threshold line 450). The indication of designated part time employees that are trending full time, as shown at area 455, is particularly useful for determining compliance with health care laws and rules regarding providing benefits to, or paying penalties for, employees whose average hours worked places them in full time status.

The system may be further configured to generate and display a message that indicates the number of employees in area 455 when the user moves their computer cursor over the area 455. For example, the user may control their cursor (e.g., using a mouse or track pack or similar input device) to move the cursor over area 455, at which point the system generates and displays a message, e.g., pop up box 465, with text such as “N out of M part time employees are trending full time” where N is the number of part time employees that corresponds to the area 455 and M is the total number of part time employees as also indicated at reference number 420. A similar message may be provided that indicates the number of employees in area 460 when the user moves their computer cursor over the area 460, e.g., “Q out of R full time employees are trending part time.”

The example described thus far uses a trending process based on averaging the number of hours per pay period per specified time. However, other trending processes may be used, such as weighted averages and/or other numerical methods. When plural different algorithms are programmed to be available for use in generating the trending chart 405, the UI 400 may include a selectable input field 470 by which the user may provide input to select a trending process from plural available trending processes.

According to aspects of the invention, the system regenerates the trending chart 405 when the user changes an input to at least at one of the fields 435, 440, 445, and 470. For example, the user may change the time period at field 445, and the system will re-query the appropriate databases to obtain data corresponding to the newly specified time period, apply the trending process to the obtained data, and generate the UI 400 including the trending chart 405 based on the new data. The system may similarly re-obtain data, re-apply the trending process, and re-generate the UI 400 and trending chart 405 based on a user change of entity at field 435, group at field 440, or trending process at field 470. In this manner, the UI 400 is reconfigurable and dynamic in that and the system will re-calculate and re-display the UI 400 including the trending chart 405 based on a change in a user specified input.

With continued reference to FIG. 4, the UI 400 may also include a listing of each individual employee that is represented in the trending chart 405. For example, the UI 400 may include a table 500 in which each row corresponds to one employee that is in the user-selected entity and user-selected group. The columns of the table 500 may include, for example: employee name 501; entity name 502; group 503; current status 504; trending status 505; average hours of service 506; medical plan offered 507; and potentially Medicaid eligible 508. Data that is displayed in these columns 501-508 is obtained by the system from one or more of the HR database, the benefits database, the payroll database, and the leaves database, or is determined based on data obtained from one or more of these databases. For example, the data in the employee name column 501, entity name column 502, and group column 503 may be obtained from the HR database. The current status column 504 indicates PT (part time) or FT (full time) and is an indication of the employee's designated status as obtained, for example, from the HR database. In this way, it is now possible to determine individual trending status, e.g., tending full time or trending part time, simultaneously for a group of individuals. This also allows the user to manipulate the data for a single user to determine how it affects compliance, thus providing thus providing technical capabilities of manipulating individual data and determining compliance effects of such manipulation on the entire group.

In embodiments, the average hours of service column 506 indicates the average hours worked per week by the specific employee for the specified time period, and may be determined by applying the trending process to data obtained from the payroll database as described above with respect to the trending chart 405. The trending status column 505 indicates PT (part time) or FT (full time), which is determined for the particular employee by comparing the employee's determined average hours of service (shown in column 506) to the threshold value (e.g., 30 hours). When the employee's determined average hours of service is greater than the threshold value, the trending status is deemed to be FT. On the other hand, when the employee's determined average hours of service is less than the threshold value, the trending status is deemed to be PT. In embodiments, the system is configured to display a warning (e.g., icon 515) when the trending status for an employee (shown in column 505) is different than the designated status of the employee (shown in column 504). In this manner, the system visually informs the user of each individual employee whose trending status is different than their designated status, which information can be useful to the user to decide which action(s) to take with respect to this employee and compliance with the healthcare law.

Still referring to the table 500 of FIG. 4, the medical plan offered column 507 contains data that indicates whether the employer currently offers medical insurance to the employee, which data may be obtained from the benefits database. The potentially Medicaid eligible column 508 contains data that indicates whether the employee is potentially eligible for Medicaid based on their state of residence (obtained from the HR database), their pay (obtained from the payroll database), and the Medicaid rules for their state of residence (which may be stored, for example, in the program data 155 or other storage of the computing device 105). Displaying whether a particular employer is potentially eligible for Medicaid is useful to the employer because, in certain circumstances of the ACA, the employer is not required to offer medical insurance to an FT employee when the FT employee is already eligible for Medicaid. Thus, making this determination and displaying the result in the table 500 provides information that the user (e.g., employer) can utilize in making business decisions regarding which action(s) to take with respect to this employee and compliance with the healthcare law.

According to aspects of the invention, the system presents the data contained in the UI 400 (e.g., the trending chart 405 and the table 500) to the user so that the user can make an informed business decision on how to handle workload and/or benefits for certain ones of the employees. For example, when the system indicates that a given employee is PT trending FT, the employer can use this information to decide whether to: maintain this employee's workload as trending FT and offer the employee medical insurance to comply with the healthcare law for FT employees; maintain this employee's workload as trending FT but not offer medical insurance, thereby opting to pay a penalty that may result; reduce the employee's workload to skew this employee toward trending PT, and not offer medical insurance since such is not required for PT employees. The system does not make suggestions for the user (employer), but rather provides data to the employer so that the employer can make their own informed decision. The data is gathered from disparate sources (e.g., HR, benefits, payroll, and leaves databases) and displayed simultaneously along with additional data that is determined from the gathered data.

Implementations of the invention thus provide a technical solution of providing an automated system and process of gathering and correlating data from disparate data sources, determining a predictive trend data based on the gathered data, and simultaneously displaying some of the gathered data with the predictive trend data for a plurality of employees. This technical solution addresses the problem that, for large groups of employees, it is difficult to have an overall picture of healthcare compliance based on the employees' actual work hours compared to their designated status.

As depicted by message 600 of FIG. 4, the system may be configured to determine an industry standard baseline for a category of employer, and present this baseline to the user so that the user may compare their practice to an industry average. For example, as described with respect to FIG. 3, the system may have access to data for plural different employers, e.g., databases 305a-d, databases 310a-d, and databases 315a-d. The system may be configured to group certain ones of the plural employers into categories based on parameters such as size (e.g., number of employees) and/or industry (e.g., retail, medical, hospitality, etc.). For each category, the system may be configured to analyze the data of all employers in that category to determine averages for that category.

For example, as shown in FIG. 4, the UI 400 may include a message 600 that indicates a determined value (e.g., G %) of a comparison parameter for the selected entity (e.g., ABC Corp) and an average value (e.g., H %) of the same comparison parameter for all entities in the same category as the selected entity. In this example, the determined value is the percentage of FT (full time) employees for which the entity (e.g., the employer) offers medical insurance. The system may determine these values (e.g., G % and H %) using data obtained from the various databases described herein. In this manner, the user may compare their practices to average practices of a group of similarly categorized employers, which may help the employer make a business decision about how to act in terms of offering benefits, paying penalties, adjusting individual employee work schedules, etc.

As depicted by message 700 of FIG. 4, the system may be configured to determine estimated financial costs for “what if?” scenarios. For example, the system can be programmed with, or have access to, the financial cost of providing medical insurance to an employee of a given entity. The system can also be programmed with, or have access to, the financial cost of the penalty for not offering medical insurance to a FT employee. Based on the number of employees trending FT that are not offered benefits, the system can be configured to determine two estimated costs: the cost (e.g., $B) of providing each of the trending FT employees with coverage (based on the financial cost of the benefit and the number of trending FT employees); and the cost ($C) of not providing the coverage to the trending FT employees (based on the penalty cost and the number of trending FT employees), as depicted at reference number 700 of the UI 400 of FIG. 4. In this manner, the employer can see the cost of each scenario and make a business decision based on the lower cost option. A penalty calculation can be accomplished by multiplying the number of employees who are PT trending FT times the penalty cost; whereas the cost of providing health care can be determined by the health care cost of the company for each employee by the number of employees who are PT trending FT. These calculations can be based on information obtained from the different databases 305a, 305b, 305c, 305d.

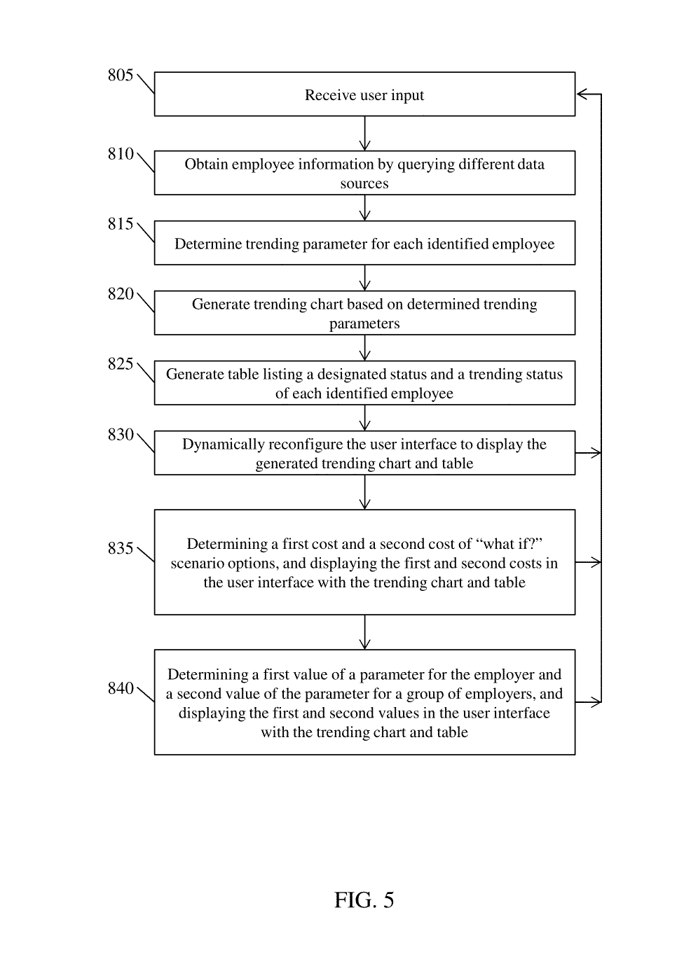

FIG. 5 depicts an exemplary flow for a process in accordance with aspects of the present invention. The exemplary flow can be illustrative of a system, a method, and/or a computer program product and related functionality implemented on the computing system of FIG. 1, in accordance with aspects of the present invention. The computer program product may include computer readable program instructions stored on computer readable storage medium (or media). The computer readable storage medium may include the one or more storage medium as described with regard to FIG. 1, e.g., non-transitory media, a tangible device, etc. The method, and/or computer program product implementing the flow of FIG. 5 can be downloaded to respective computing/processing devices, e.g., computing system of FIG. 1 as already described herein, or implemented on a cloud infrastructure as described with regard to FIG. 2. The process of FIG. 5 may be carried out in the environment of FIG. 3, for example. Accordingly, the processes associated with each flow of the present invention can be implemented by special purpose hardware-based systems that perform the specified functions or acts or carry out combinations of special purpose hardware and computer instructions.

At step 805, a computing device (e.g., computing device 105 running trending tool 153) receives a user input. In embodiments, the user input is received at a user interface (e.g., UI 400) and includes a selection of a specified date or date range (e.g., at field 445 of UI 400). The user input may also include a selection of at least one of: an entity (e.g., at field 435 of UI 400), a group (e.g., at field 440 of UI 400), and a trending process (e.g., at field 470 of UI 400).

At step 810, the computing device obtains employee information by querying different data sources. In embodiments, step 810 includes the computing device querying the different databases in order to obtain data used in generating the trending chart, as described with respect to FIG. 4. The employee information may include, for example: name or other identifier of each employee that meets the criteria of the user selections from step 805; employee name, employee state of residence, employee designated status (full time or part time), entity (employer) name, and group name to which the employee belongs within the entity, whether medical insurance (if any) is offered to each employee, the cost to the employer of the medical insurance that is offered, whether the employee has accepted the offered medical insurance, actual hours worked by the employee including dates the hours were worked, hourly pay rate of the employee, and any special unpaid leave taken by the employee including dates the leave was taken and how many hours of leave was taken.

At step 815, the computing device determines a value of a trending parameter for each identified employee. In embodiments, the value of the trending parameter is determined by applying a trending process to a portion of the data obtained for each employee, e.g., as described with respect to FIG. 4. In a particular embodiment, the trending parameter is an average number of hours worked per week by the employee during the time period specified by the user input.

At step 820, the computing device generates a trending chart based on the determined values of the trending parameters for the identified employees. In embodiments, the trending chart comprises a first line of plotted values of the trending parameters for designated part time employees, and a second line of plotted values of trending parameters for designated full time employees, e.g., as described with respect to FIG. 4. The trending chart may also include a threshold indicator, first visual indication, and second visual indication as described with respect to FIG. 4.

At step 825, the computing device generates a table that lists each identified employee. In embodiments, as described with respect to FIG. 4, the table may include for each identified employee: entity name, group, current (designated) status, trending (determined) status, value of the trending parameter, whether medical insurance is offered, and whether Medicaid is potentially eligible.

At step 830, the computing device dynamically reconfigures the user interface to display the generated trending chart and table. In embodiments, the computing device alters the user interface by displaying the trending chart in a first changeable area of the user interface and by displaying the table in a second changeable area of the user interface. The user interface may also be altered to display other information, for example total number of employees, number of PT employees, number of FT employees, etc., as described with respect to FIG. 4.

At step 835, the computing device determines a first cost and a second cost of “what if?” scenario options, and displays the first and second costs in the user interface with the trending chart and table. In embodiments, step 835 is performed in the manner described with respect to message 700 of FIG. 4.

At step 840, the computing device determines a first value of a parameter for the employer and a second value of the parameter for a group of employers, and displays the first and second values in the user interface with the trending chart and table. In embodiments, step 840 is performed in the manner described with respect to message 600 of FIG. 4.

As indicated by the arrows extending from step 830 to step 805, from step 835 to step 805, and from step 840 to step 805, the process may be repeated with new user inputs. For example, the user may input at least one of: different date range (e.g., at field 445), a different entity (e.g., at field 435), a different group (e.g., at field 440), and a different algorithm (e.g., at field 470). Based upon the new (changed) user input, the computing device repeats the steps to generate a new trending chart and a new table. In this way, the user interface is dynamically reconfigurable based on input from the user, and the user may utilize this feature to analyze different scenarios.

The foregoing examples have been provided merely for the purpose of explanation and are in no way to be construed as limiting of the present invention. While aspects of the present invention have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although aspects of the present invention have been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A method of analyzing compliance with a healthcare law, comprising:
obtaining employee information about plural employees by querying at least one data source via computer-based network communication;
determining a respective trending parameter for each of the plural employees; and
generating and displaying a trending chart in the user interface, wherein the trending chart includes: a first curve based on the determined trending parameters of ones of the plural employees designated as part time, and a second curve based on the determined trending parameters of ones of the plural employees designated as full time;
wherein the obtaining, the determining, and the generating and displaying are performed by a trending tool running on a computing device.

2. The method of claim 1, wherein the determining the respective trending parameter for each of the plural employees comprises applying a trending process to a portion of the obtained employee information.

3. The method of claim 1, wherein the determined respective trending parameter for each of the plural employees comprises an average number of hours worked per week during a user-specified time period.

4. The method of claim 1, wherein:
the at least one data source comprises plural different databases; and
the obtaining the employee information comprises querying each of the plural different databases.

5. The method of claim 4, wherein the plural different databases comprises a human resources database and a payroll database.

6. The method of claim 5, wherein the employee information comprises:
a designated status as one of part time or full time for each one of the plural employees obtained from the human resources database; and
actual hours worked by each one of the plural employees obtained from the payroll database.

7. The method of claim 1, further comprising determining a number of the plural employees designated as part time that are trending as full time by comparing the determined trending parameters to a pre-defined threshold value.

8. The method of claim 7, further comprising displaying the number of the plural employees designated as part time that are trending as full time based on a user moving a cursor over an indication area of the trending chart.

9. The method of claim 7, further comprising:
determining a first financial cost of offering medical insurance to the number of the plural employees designated as part time that are trending as full time;
determining a second financial cost of paying a penalty for not offering medical insurance to the number of the plural employees designated as part time that are trending as full time; and
displaying the first financial cost and the second financial cost in the user interface with the trending chart.

10. The method of claim 1, further comprising receiving a user input at the computer generated user interface prior to the obtaining, the determining, and the generating and displaying, wherein:
the obtaining is performed based on the receiving the user input; and
the user input comprises a specified time period for which to generate the trending chart.

11. The method of claim 10, wherein the user input comprises a selection of an employer from a list of plural employers for which to generate the trending chart.

12. The method of claim 11, wherein the user input comprises a selection of a group of employees from a list of plural groups of employees within the selected employer for which to generate the trending chart.

13. The method of claim 1, further comprising:
determining a trending status for each one of the plural employees by comparing the determined trending parameters to a threshold value; and
generating and displaying a table in the user interface with the trending chart, wherein the table lists the determined trending status for each one of the plural employees.

14. The method of claim 13, wherein the table also lists:
a designated status for each one of the plural employees;
the determined trending parameter for each one of the plural employees.

15. The method of claim 14, further comprising:
displaying a warning in the user interface based on determining that the designated status for one of the plural employees is different than the trending status for the one of the plural employees.

16. The method of claim 1, wherein the plural employees are employed by an employer and further comprising:
determining a value of a comparison parameter for the employer;
determining an average value of the comparison parameter for plural employers; and
displaying the value of a comparison parameter for the employer and the average value of the comparison parameter for plural employers in the user interface with the trending chart.

17. A computer system for analyzing compliance with a healthcare law, comprising:
a hardware memory device that stores programming instructions of a trending tool; and
a hardware processor that executes the program instructions and causes the computer system to:
receive a user input at a computer generated user interface;
based on the user input, obtain employee information about plural employees by querying plural different databases via computer-based network communication;
determine a respective trending parameter for each of the plural employees by applying a trending process to a portion of the obtained employee information; and
generate and display a trending chart in the user interface, wherein the trending chart includes: a first curve based on the determined trending parameters of ones of the plural employees designated as part time, and a second curve based on the determined trending parameters of ones of the plural employees designated as full time;
wherein the determined respective trending parameter for each of the plural employees comprises an average number of hours worked per week during a specified time period, and
the user input comprises the specified time period.

18. The computer system of claim 17, wherein the program instructions cause the computer system to:
determine a trending status for each one of the plural employees by comparing the determined trending parameters to a threshold value; and
generate and display a table in the user interface with the trending chart, wherein the table lists:
the determined trending status for each one of the plural employees.
a designated status for each one of the plural employees;
the determined trending parameter for each one of the plural employees;
an indication, for each one of the plural employees, of medical insurance being one of offered and not offered; and
an indication, for each one of the plural employees, of potential eligibility for Medicaid.

19. The computer system of claim 17, wherein the program instructions cause the computer system to:
receive another user input at the user interface;
generating another trending chart based on repeating the obtaining and the determining for the other user input; and
dynamically reconfigure the user interface to display the other trending chart.

20. A computer program product for analyzing compliance with a healthcare law, the computer program product comprising computer readable program instructions stored on computer readable storage medium, the computer readable program instructions being executable on a computing device to cause the computing device to:
receive a user input at a computer generated user interface;
based on the user input, obtain employee information about plural employees by querying a human resources database and a payroll database via computer-based network communication;
determine a respective trending parameter for each of the plural employees by applying a trending process to a portion of the obtained employee information; and
generate and display a trending chart in the user interface, wherein the trending chart includes: a first curve based on the determined trending parameters of ones of the plural employees designated as part time, and a second curve based on the determined trending parameters of ones of the plural employees designated as full time;
wherein the determined respective trending parameter for each of the plural employees comprises an average number of hours worked per week during a specified time period,
the user input comprises the specified time period, and
the table lists a determined trending status for each one of the plural employees.
